(19) United States
(12) Patent Application Publication
(10) Pub. No.: US 2016/0193784 A1
(43) Pub. Date: Jul. 7, 2016

(54) 3D PRINTER AND SCANNER FRAME

(71) Applicants: Stoyan Tadin, Toronto (CA); William Chang, Toronto (CA); Mie Uriyama Tadin, Roseneath (CA)

(72) Inventors: Stoyan Tadin, Toronto (CA); William Chang, Toronto (CA); Mie Uriyama Tadin, Roseneath (CA)

(21) Appl. No.: 14/983,652

(22) Filed: Dec. 30, 2015

Related U.S. Application Data
(60) Provisional application No. 62/099,316, filed on Jan. 2, 2015.

(51) Int. Cl. B29C 67/00; B23K 31/02; B21D 51/10

(52) U.S. Cl. CPC B29C 67/0085; B21D 51/10; B23K 31/027; B29C 67/0051; B33Y 30/00

(57) ABSTRACT

Systems and methods for providing lightweight and durable portable 3D printer and scanner having a vertically oriented cylindrical form. A device can include housing assembly consisting of a uni-body shell with plates, rings and apertures. By containing printer and scanner parts within the uni-body housing, the product may provide greater resistance to external loads.

### CROSS-REFERENCE

This application claims the benefit of the filing date of U.S. Provisional Patent Application Ser. No. 62/099,316 filed Jan. 2, 2015 entitled 3D PRINTER AND SCANNER FRAME, the contents of which are hereby expressly incorporated by reference into the Detailed Description of the Drawings herein below.

### FIELD

The present application describes various embodiments regarding systems and methods for providing lightweight and durable portable 3D printer and scanner having a vertically oriented cylindrical form.

### BACKGROUND

It is desirable to reduce housing assembly deflection during operation of the 3D printer in order to reduce unwanted printer head movement. Unwanted printer head movement can result in printed parts having incorrect geometry and poor surface finish. Unwanted printer head movement reduces the accuracy of the printer. It is also desirable to reduce housing assembly deflections because they may cause vibrations that can exacerbate unwanted printer head movement.

Similarly it is desirable to reduce housing assembly deflection during operation of the 3D scanner in order to reduce the unwanted movement of the lasers and cameras as well as reduce unwanted movement of the turntable. By reducing these movements the quality of the scan is improved. The housing may also provide structure to other tools in lieu of the print head extruder including, but not limited to a CNC mill, a laser and a water jet.

It is desirable to minimize the volume of the 3D printer and 3D scanner, herein called the device, for a given build (or scan) volume in order to make it more efficient to ship and store the product prior to delivery to the consumer. In addition it is advantageous to reduce the volume of the product so that it consumes less space as well as improving portability during transport by the consumer.

It is desirable to reduce the device footprint for a given build area in order to limit the surface area occupied by the device (similar to the desire to reduce the volume of the device mentioned above). In addition, it is of interest to reduce the footprint/build (scan) area ratio to make it more efficient to ship and store the product prior to delivery to the consumer. Conventional 3D printer housings are generally rectangular in plan. And in general conventional 3D printers have a large footprint relative to the size of the build platform. Conventional housings surrounding the working components are cumbersome, inefficient and take up to 75% of the area as compared to the usable “working build area”. A conventional 3D printer may have a 14″×15″ footprint area while providing only a 7″×7″ build area.

In addition to reducing the volume of the device, it is desirable to reduce its weight and make a printer which is more portable by making it less cumbersome and more resistant to external forces applied during transport.

Other difficulties with existing systems, methods and techniques may be appreciated in view of the Detailed Description of the Drawings herein below.

### SUMMARY

A device can include housing assembly consisting of a uni-body shell with plates, rings and apertures. The housing can also be referred to as frame or enclosure.

By containing printer and scanner parts within the uni-body housing, the product can provide greater resistance to external loads. The support of the printer (scanner) assembly within the housing results in a strong construction that does not have superfluous parts makes for a relatively lightweight product that is easily portable. The user does not need to be concerned about impairing functionality and/or having to re-calibrate the units subsequent to moving the equipment.

The uni-body cylindrical form limits the fasteners, hardware and joints associated with a faceted and multi-body construction. The accuracy of the device is increased because fewer housing parts and joints between parts (bodies) because each joint required clearance and has propensity for unwanted movement. Also reducing the number of parts reduces the cost of assembly.

### BRIEF DESCRIPTION OF THE DRAWINGS

Embodiments will now be described by way of examples with reference to the accompanying drawings, in which like reference numerals are used to indicate similar features, and in which:

FIG. 1a shows isometric view of 3D printer. The reference axes are shown.

FIG. 1b shows a side view of 3D printer.

FIG. 1c is a vertical section view from FIG. 1b.

FIG. 1d is a horizontal section view from FIG. 1b.

FIG. 2 shows device shell housing.

FIG. 3a is an isometric view of 3D printer.

FIG. 3b is a front view of printer.

FIG. 3c is an isometric view of 3D printer with some components hidden.

FIG. 3d is an exploded view of the assembly shown in FIG. 3c.

FIG. 3e is a side view of printer.

FIG. 3f is a section view from FIG. 3e.

FIG. 3g is the upper horizontal section view from FIG. 3e.

FIG. 3h is the lower horizontal section view from FIG. 3e.

FIG. 3i is a detail view from FIG. 3f.

FIG. 4 shows the plan views of printer and a prior art printer.

FIG. 5a is an isometric view of uni-body 3D printer shell housing with 5 sides.

FIG. 5b is a plan view of the printer housing shown in FIG. 5a.

FIG. 6a is an isometric view of a printer housing with an elliptical footprint.

FIG. 6b is a plan view of the printer housing shown in FIG. 6a.

FIG. 7 shows an isometric view of a printer housing with front and rear openings.

FIG. 8 is an isometric view of spool dispenser tray.

FIG. 9a is an isometric view of spool dispenser tray being inserted into housing.

FIG. 9b is a side view of the assembly shown in FIG. 9a.

FIG. 9c is a plan view of the assembly shown in FIG. 9a.

FIG. 10 is an isometric view of spool dispenser tray.

FIG. 11a is an isometric view of spool dispenser tray being inserted into ring.

FIG. 11b is a side section of spool dispenser tray inserted into ring.

FIG. 11c is a plan view of the assembly shown in FIG. 11b.

### DETAILED DESCRIPTION OF EXAMPLE EMBODIMENTS

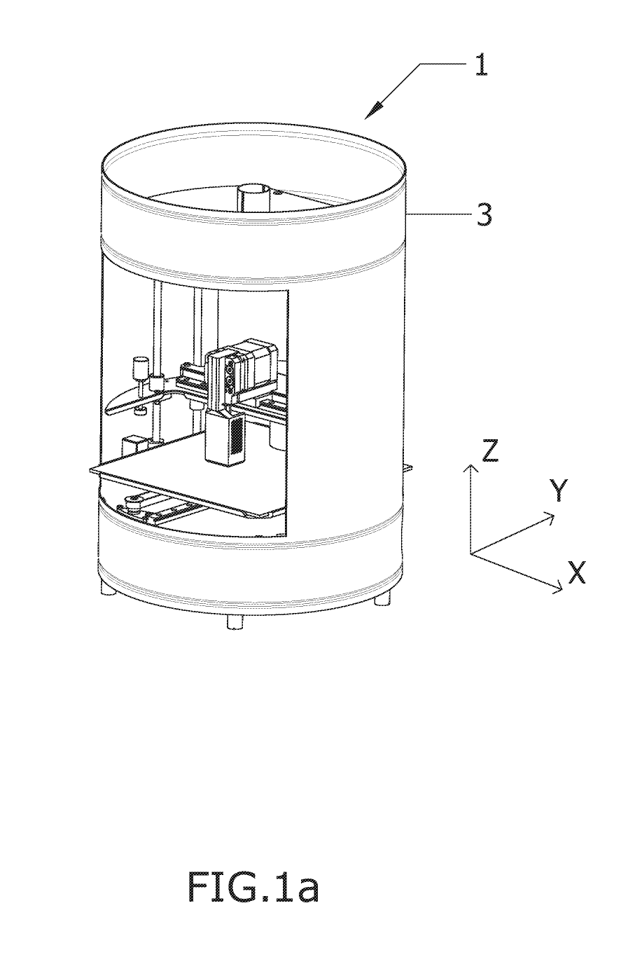

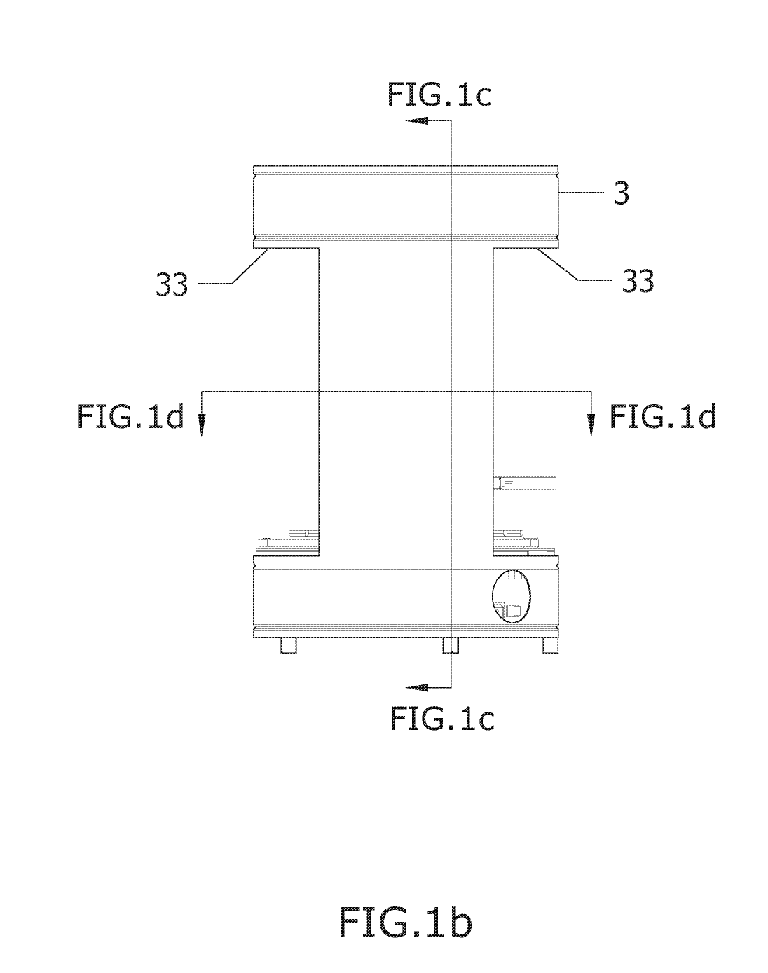

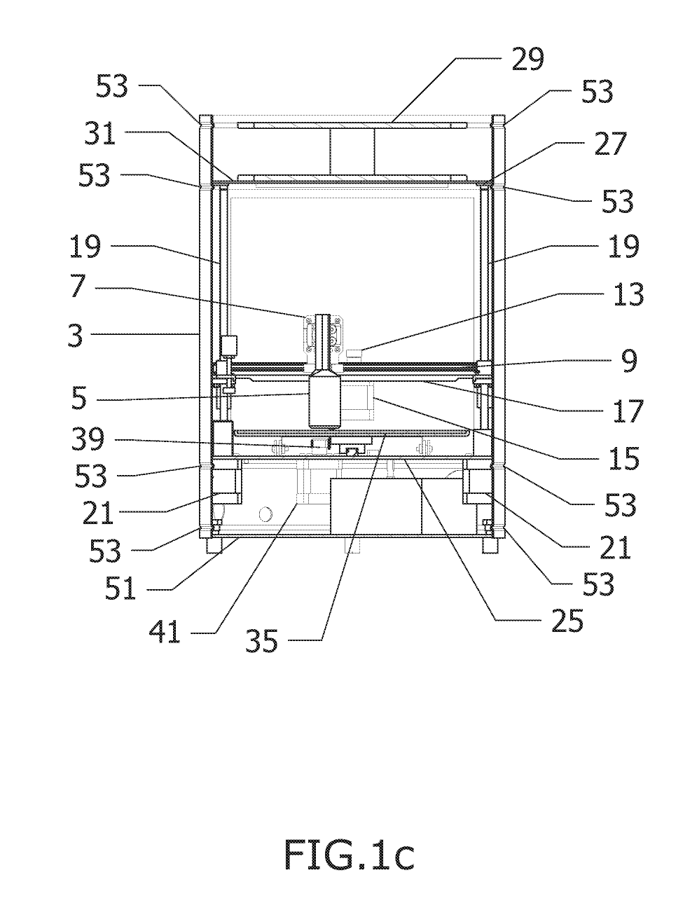

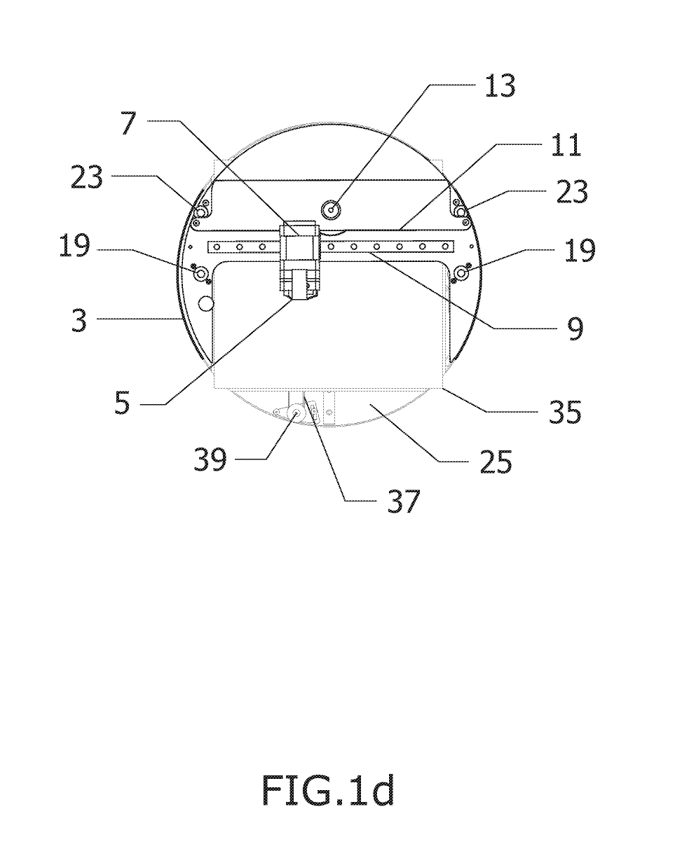

FIG. 1a shows the reference axes of 3D printer 1. These axes are referred to throughout this application.

Referring to FIG. 1a-1d, within shell housing 3, printer head assembly 5 is driven by filament motor 7 which moves along X rail 9 driven by X belt 11 on X drive pulley 13 powered by X motor 15. All supported by XZ-axis assembly plate 17. Lead screw 19 driven by Z motors 21 along with linear bearing rods 23 are held by YZ-axis assembly plate 25 which is disc-shaped and upper retainer ring 27 at the top. Holes in upper retainer ring 27 and YZ-axis assembly plate 25 serve as datum for lead screw 19 and linear bearing rods 23. Filament spool 29 is supported by spool dispenser tray 31. Shell housing 3 has a cylindrical form with front and rear openings 33 that provide access and range of motion to build platform 35. Build platform 35 is driven by Y belt 37 on Y drive pulley 39 by Y motor 41. Beads 53 are horizontal to ensure parallel YZ-axis assembly plate 25 and upper retainer ring 27 mounting which ensures vertical lead screw 19 and linear bearing rod 23 alignment and smooth raising and lowering of build platform 35. Beads 53 maintain roundness of shell housing 3 which is important for tight tolerances of the assembly. Tight tolerances decrease deflection of the assembly. Beads 53 of the shell housing 3 along with plates 51, 25, and ring 27 serve to maintain the cylindricity of the housing. As shown in FIG. 1a, in an example embodiment, the build platform 35 can extend through at least one or both of the apertures (windows) defined by the shell housing 3.

The cylindrical shape has hoop strength as well as compressive strength. The cylindrical shell housing 3 reduces the stress and deflection due to stress because there are no corners in plan view in this embodiment. Corners are stress concentrators.

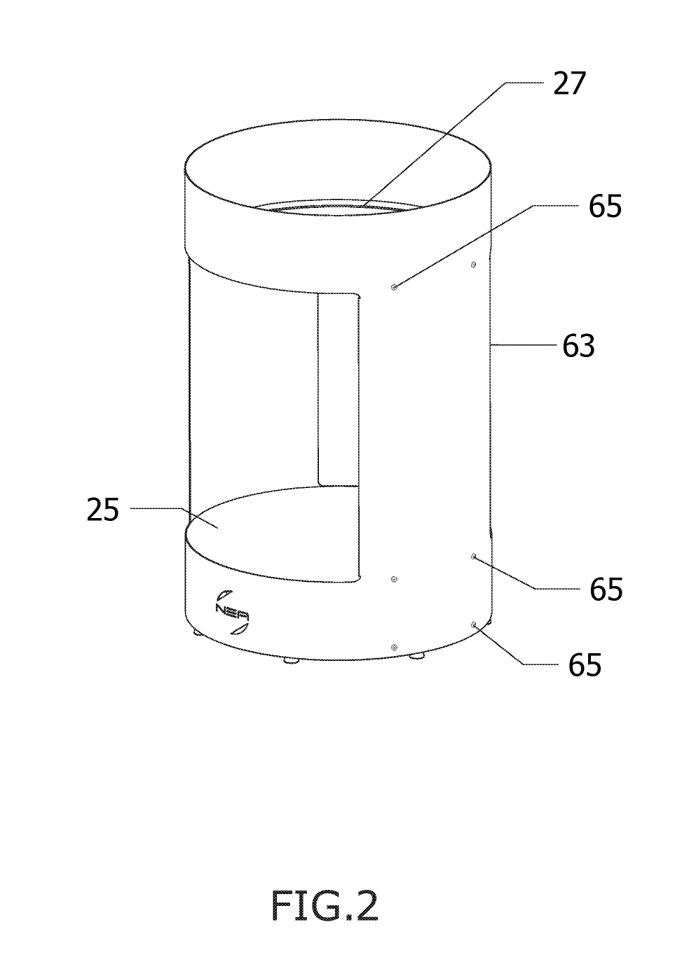

Shell housing 63 in FIG. 2, an alternate embodiment to housing 3, does not have beads. Threaded fasteners 65 or (rivets) hold YZ-axis assembly plate 25, upper retainer ring 27 and bottom cover plate 51 in place rather than the beads shown previously. Welds can also be used in lieu of fasteners.

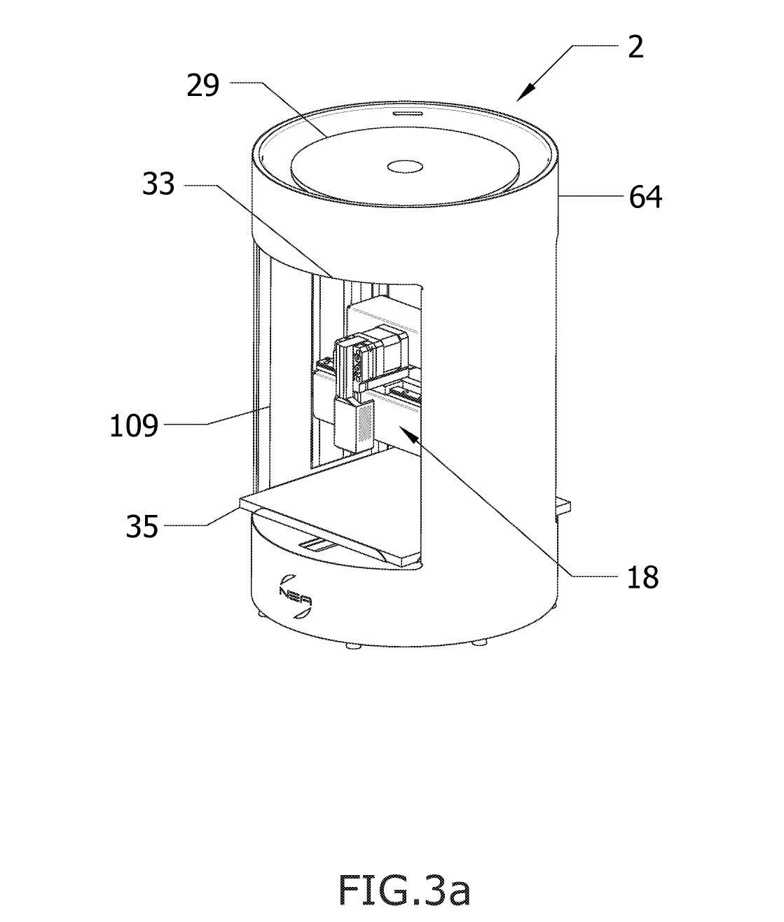

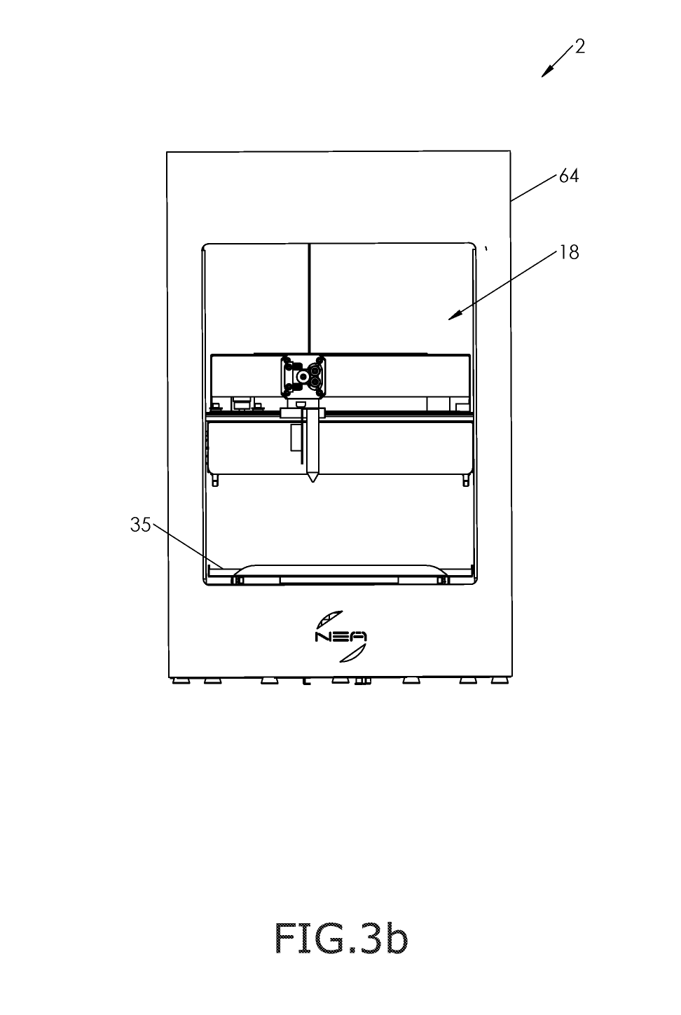

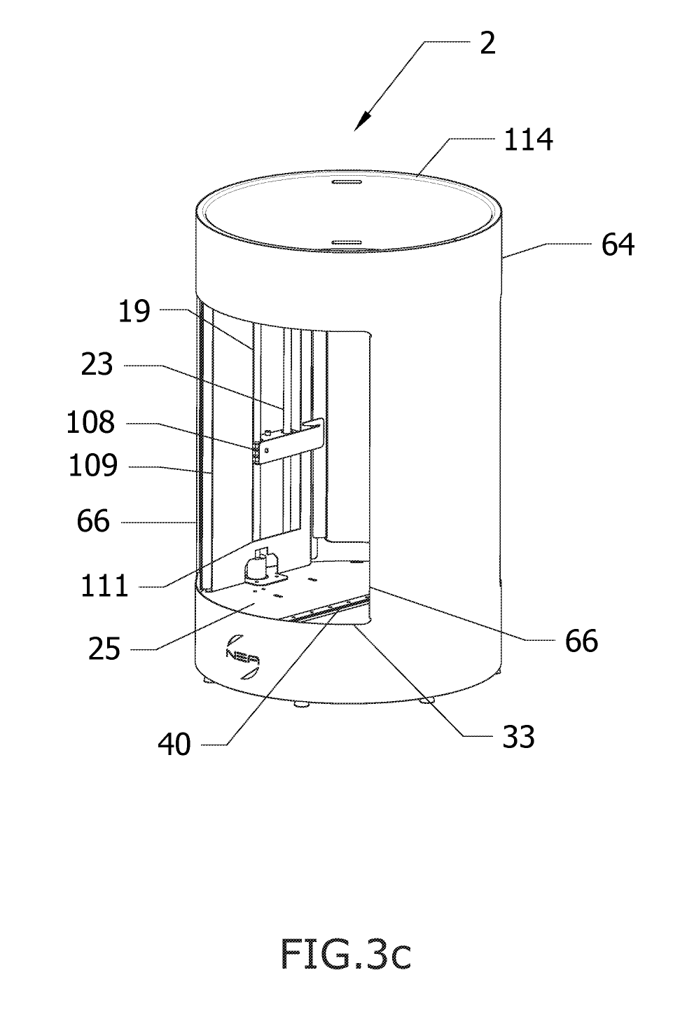

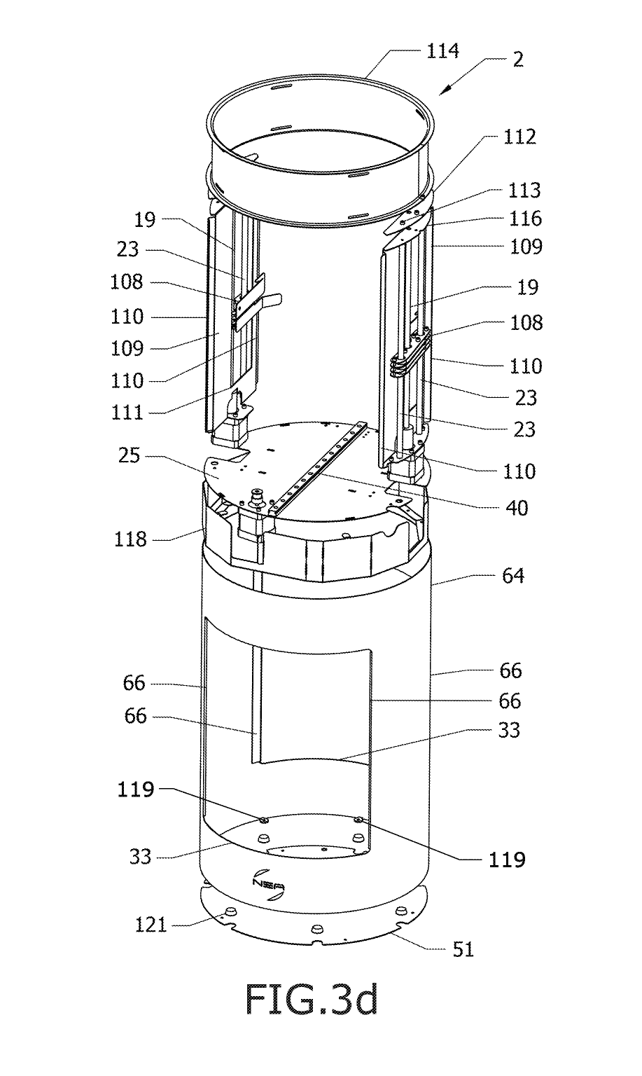

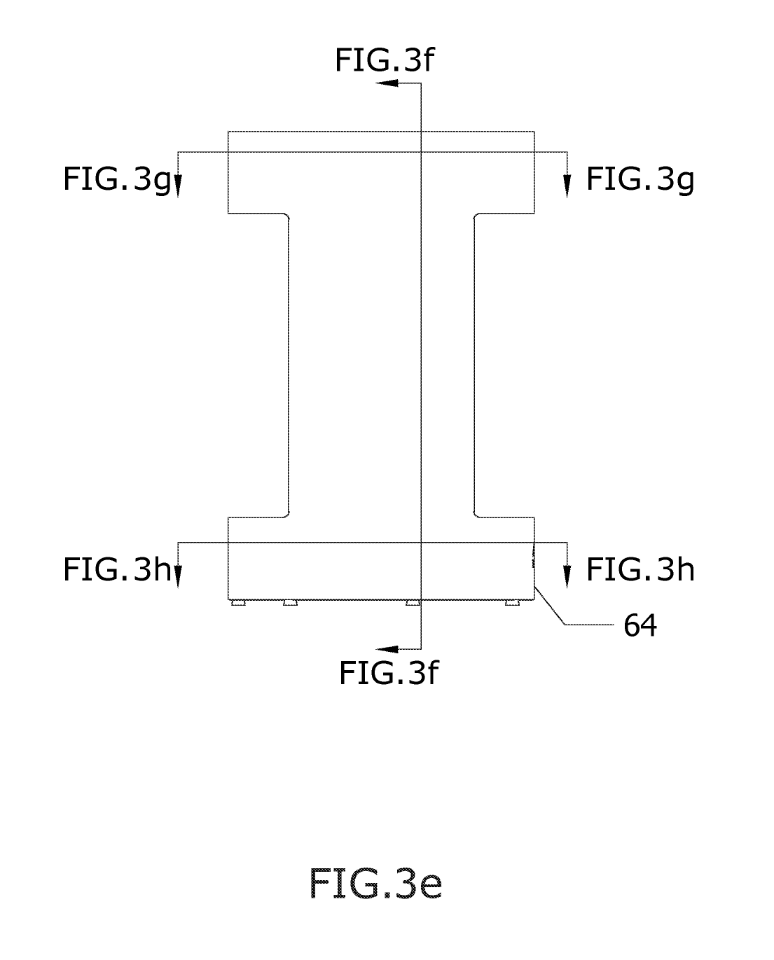

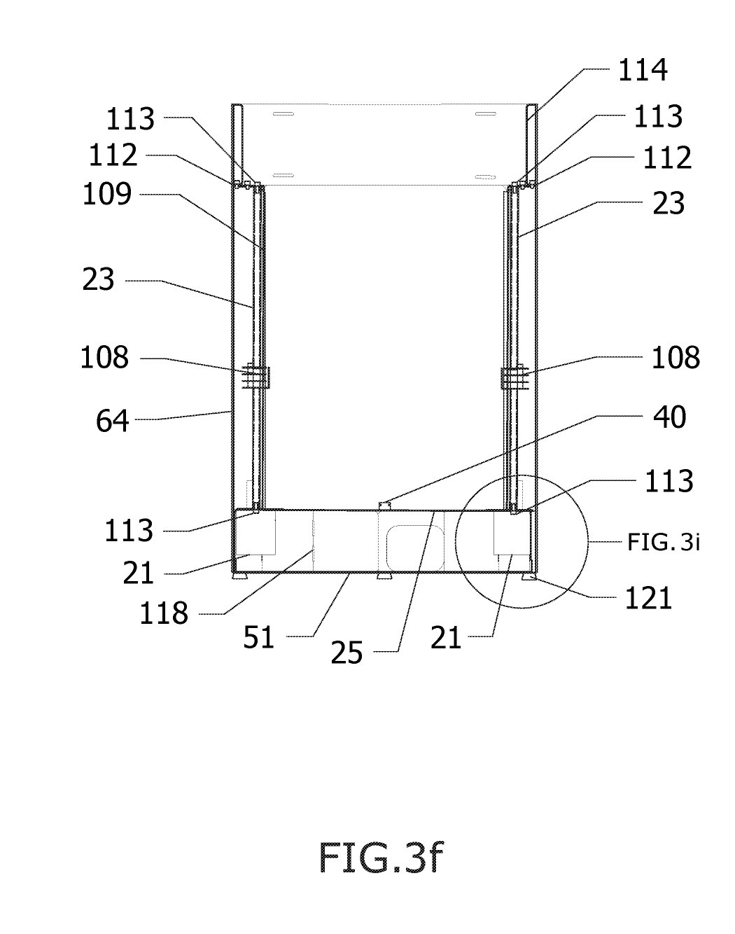

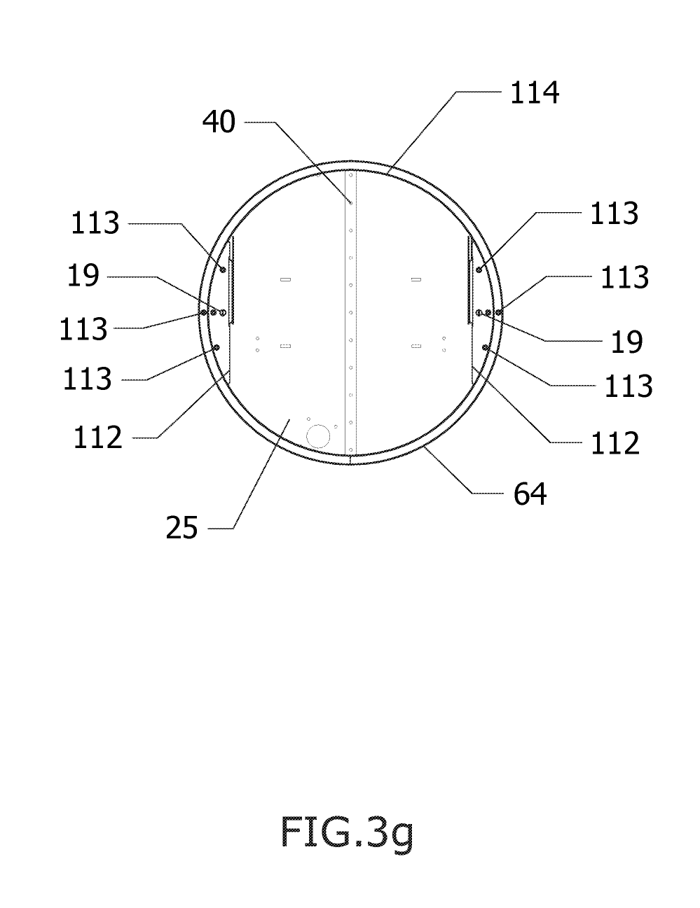

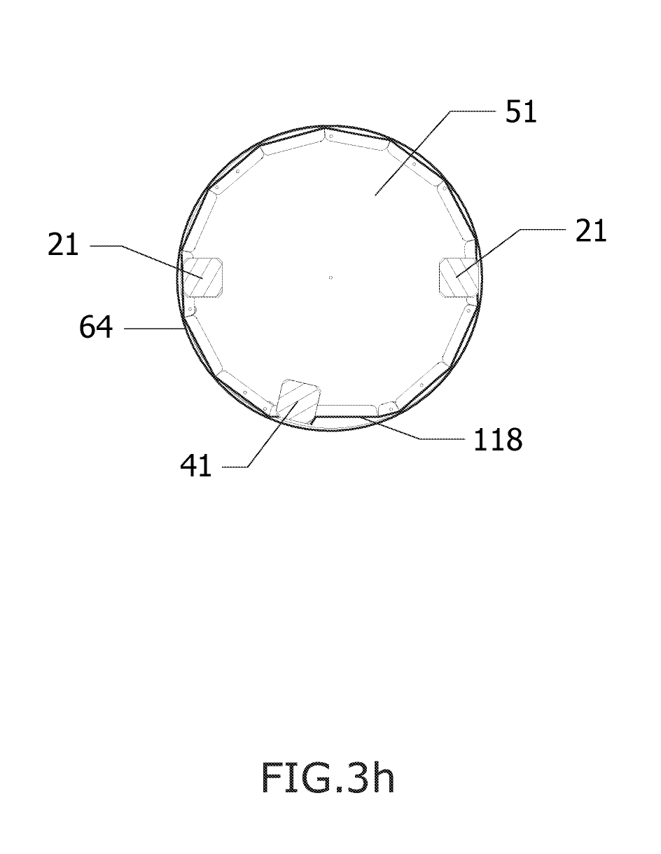

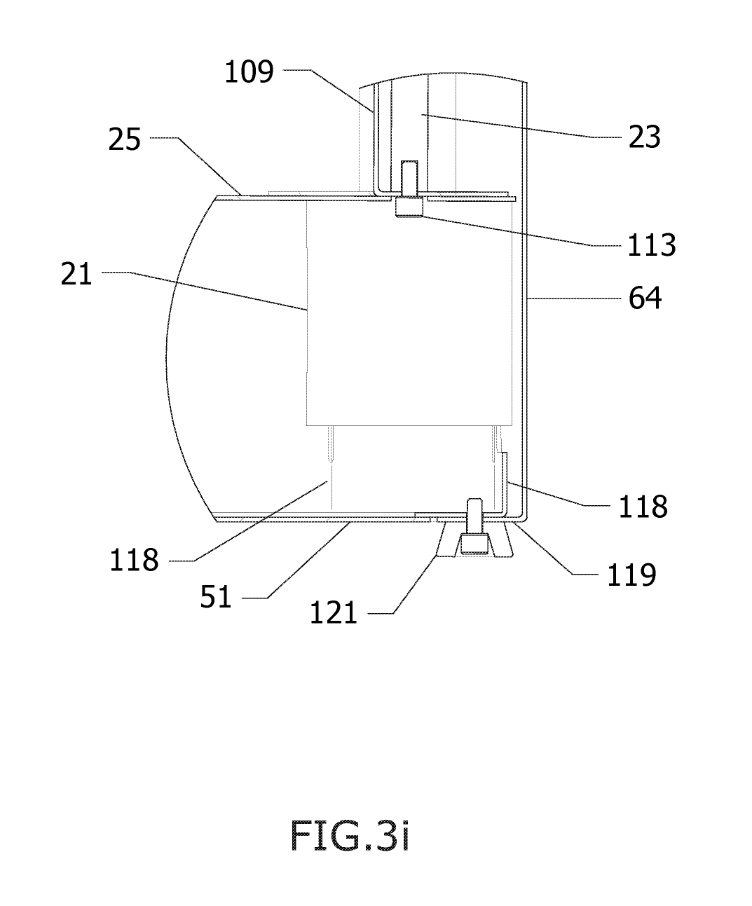

FIG. 3a is an isometric view of an alternate embodiment showing 3D printer 2. FIG. 3b is a front view of printer 2. Printer 2 has shell housing 64, XZ axis assembly 18 (consisting of print head assembly, filament motor, X drive assembly and CPU), build platform 35 and filament spool 29.

Referencing FIGS. 3c-3i, spool dispenser tray 31, filament spool 29, XZ axis assembly 18 and build platform 35 (including Y drive system and cover) have been removed for clarity. Shell housing 64 has circular tabs 119. Circular tabs 119 are integral to shell housing 64—cut flat and bent at 90 degrees after housing 64 is rolled into its cylindrical form. Tabs 119 serve to support the structure and assembly components and locate the components vertically. Elastomeric feet 121 are mounted beneath circular tabs 119. Standoff 118 is supported by circular tabs 119. YZ axis assembly plate 25 is stiffened by Y rail 40 that supports Y linear bearing for build platform 35. YZ axis assembly plate 25 is supported by standoff 118. Z motor mount brackets 109 are supported by and fastened to YZ axis assembly plate 25. Plate 112 bolts to flange 116 of Z motor mount bracket 109 and to bottom flange of channel ring 114. Bottom cover plate 51 has cutouts that allow it to fit around elastomeric feet 121. Bottom cover plate 51 is fastened to the underside of standoff 118. Motor mount brackets 109 have slots 111 through which X-axis assembly plate 17 extends to reach lead screw (jack screw) 19 and linear bearing rods 23.

Channel ring 114 and YZ axis assembly plate 25 in conjunction with shell housing 64 serve to provide horizontal restraint to Z motor mount bracket 109, linear bearing rods 23, and ultimately elevator brackets 108 that support XZ axis assembly 18 and printer head 5—limiting the deflection, and deflection causing vibrations, thereby improving the quality of the printed part.

Y motor 41 and Y drive system Z motors 21 and lead screws 19 are supported by YZ axis assembly plate 25, standoff 118, tabs 119 and feet 121. These collaborate in supporting and limiting vertical deflection of elevator brackets 108 that support XZ axis assembly 18 and printer head 5—limiting the deflection, and deflection causing vibrations, thereby improving the quality of the printed part.

Bottom cover plate 51, YZ assembly plate 25, and channel ring 114 have a locational clearance fit with the inside of shell housing 64 to enable assembly and to provide radial strength. They may also be welded to shell housing 64.

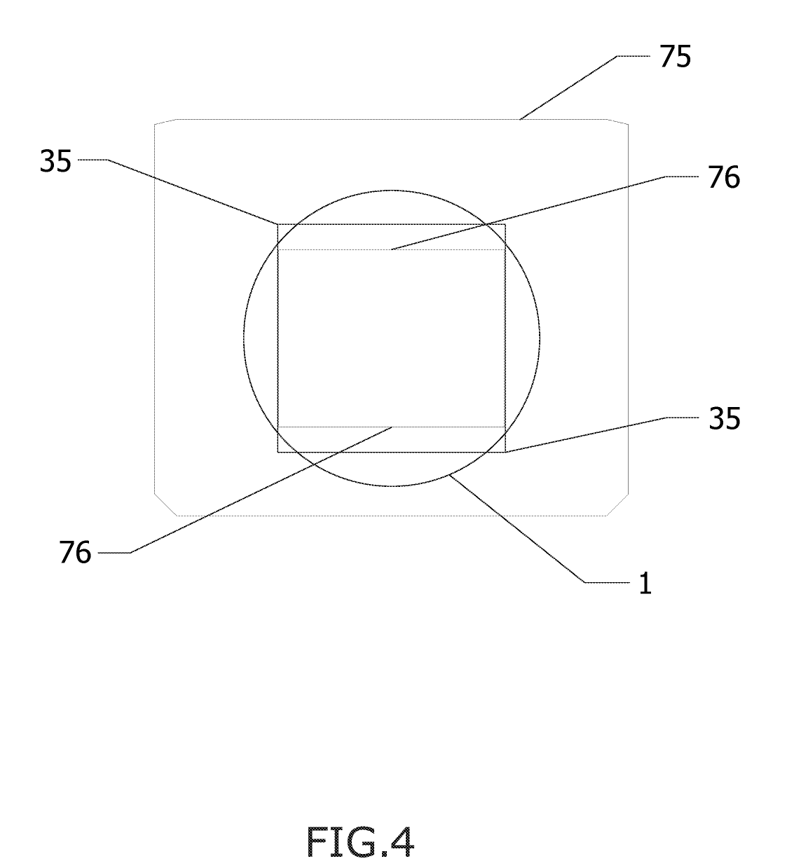

For footprint area comparison, FIG. 4 shows the plan view of a prior art printer 75 and its build platform 76 with this novel 3D printer 1 and its build platform 35. The build to footprint percentage for printer 75 is 21% whereas printer 1 is 67%.

Printer 1 has a minimized circular footprint; Z motors 21 are within the circular footprint, X motor 15 is above build platform 35, and filament spool 29 is positioned horizontally within the footprint. The combination of these features optimizes the ratio of build platform area to printer footprint.

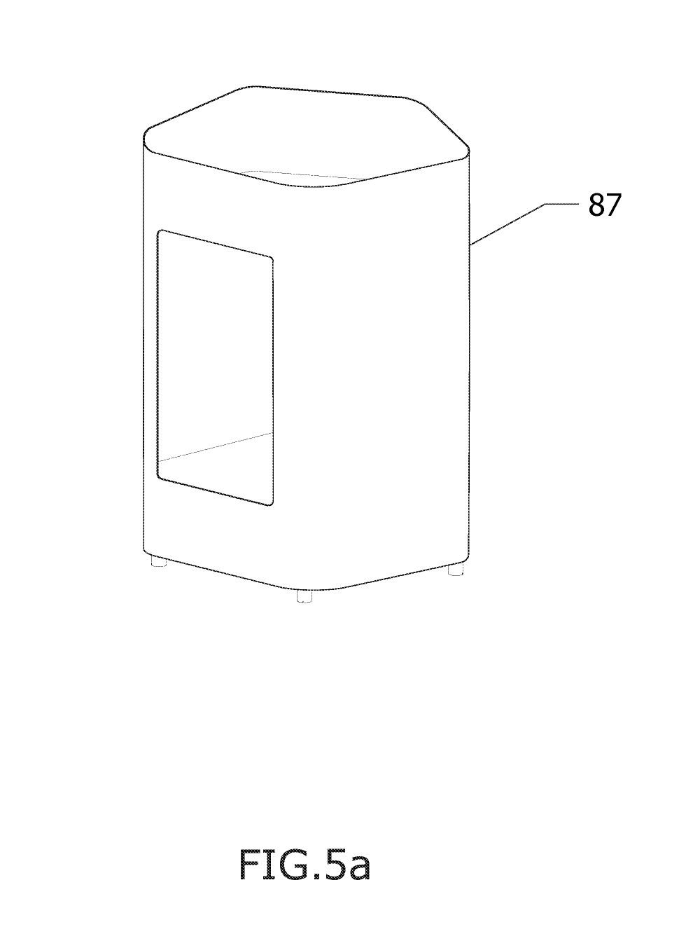

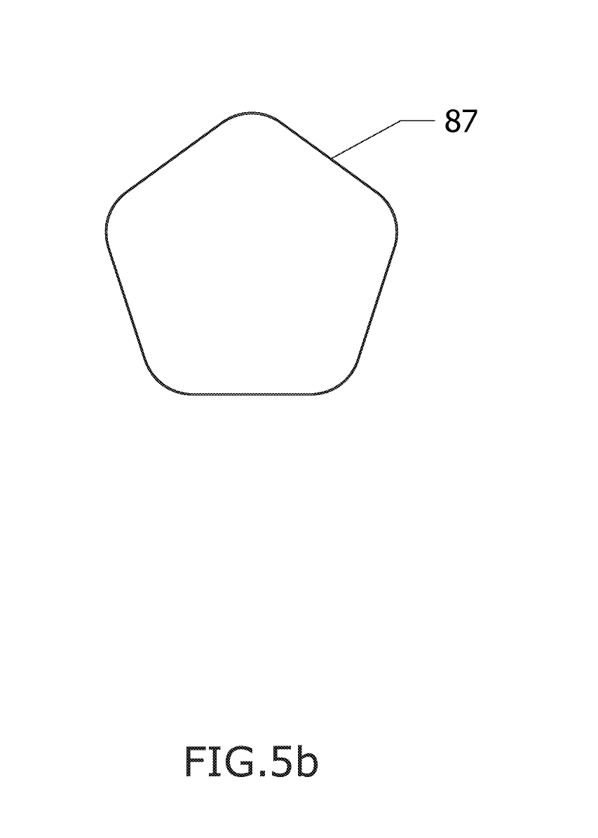

FIGS. 5a and 5b show uni-body 3D printer shell housing 87 with 5 sides. The filleted corners reduce stress concentration compared to unfilleted corners especially ones made of flat panels. A polygon shape shell housing with 5 or more sides and filleted corners may be employed to give strength to the assembly. An extruded polygon with an infinite number of sides can be considered a cylinder which had been disclosed in this application.

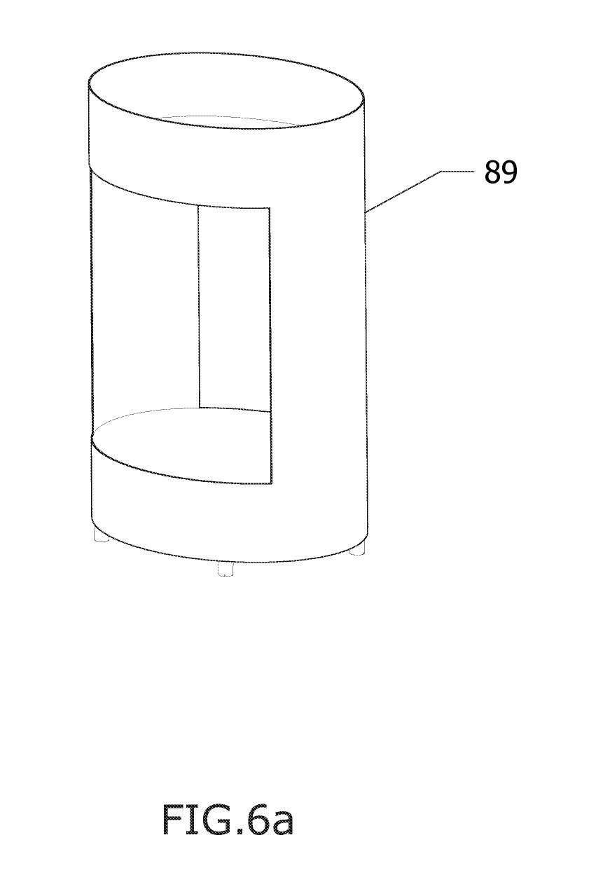

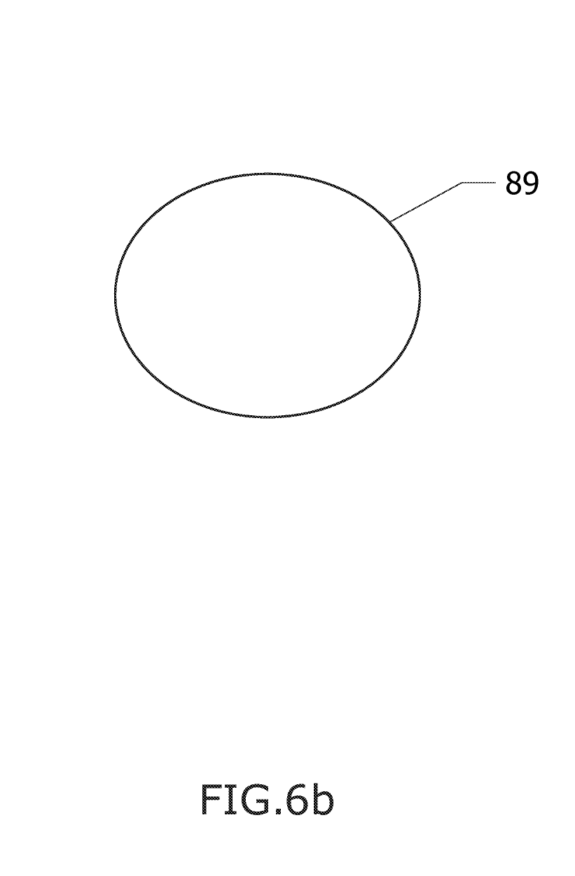

FIGS. 6a and 6b show uni-body 3D printer shell housing 89 with a generally elliptical footprint. The form of the shell housing is to reduce stress concentration associated with flat panels. Although an elliptical footprint is shown here, an oblong footprint is envisioned as an effective alternative.

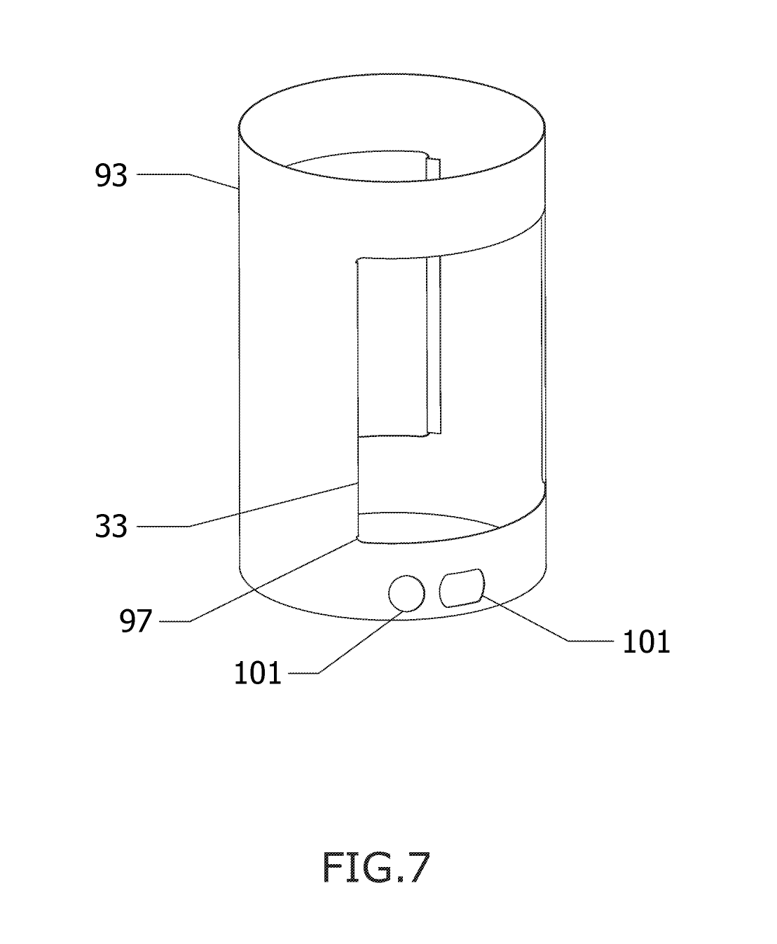

FIG. 7 shows 3D printer shell housing 93 with front and rear openings. Opening 33 where the part is accessed and the build platform is located has filleted corners 97 for a stronger housing with reduced stress concentration as compared with unfilleted corners. Similarly ports 101 for connecting electrical power or connecting to other devices like computers are either round, oblong, elliptical or rectangular with filleted corners to reduce stress concentration. Reducing stress concentration ultimately reduces the thickness and weight of material that can be employed without housing failure.

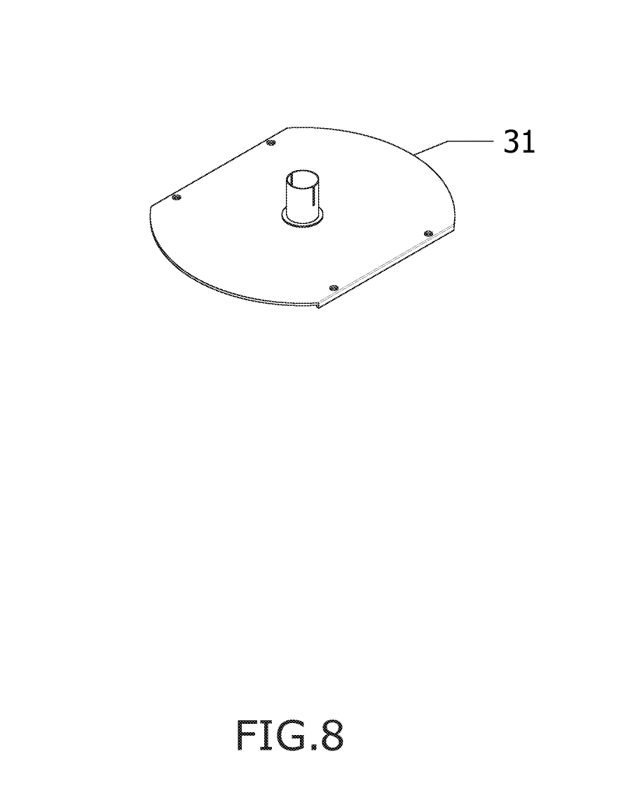

FIG. 8 is an isometric view of spool dispenser tray 31.

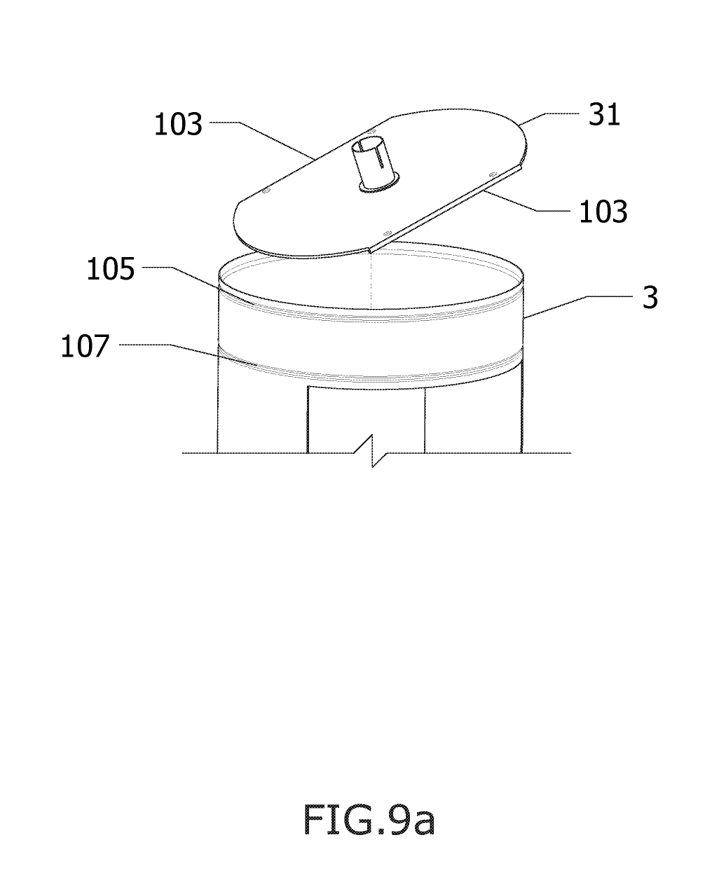

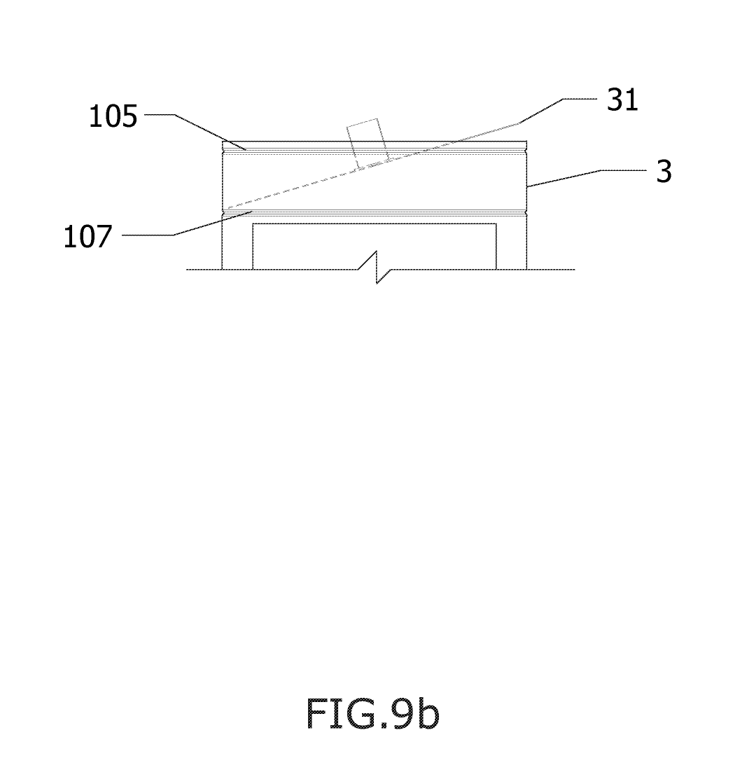

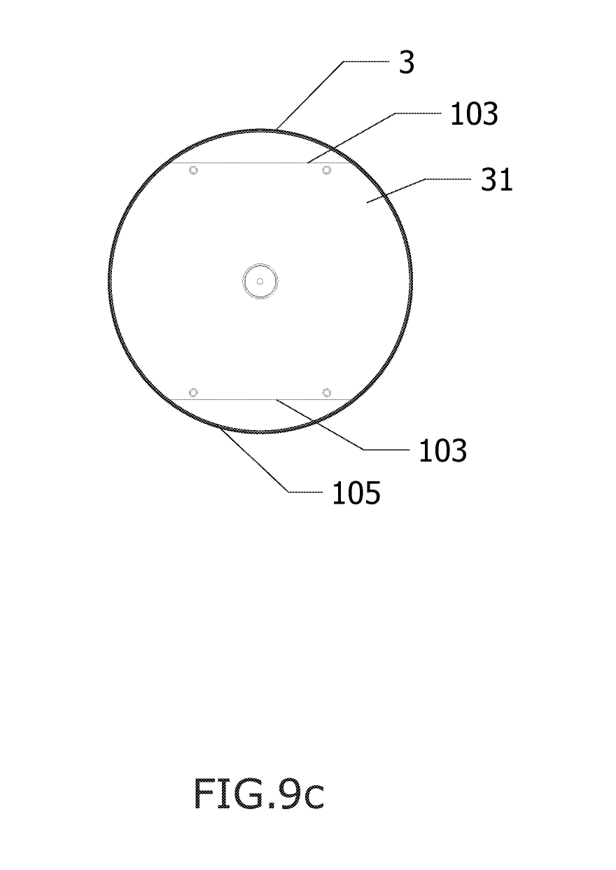

FIGS. 9a -9c show spool dispenser tray 31 being inserted onto second bead 107 of shell housing 3. Spool dispenser tray 31 has cord side cuts 103 in order to clear first bead 105. Spool dispenser tray 31 can be inserted onto bead 105 or 107; bead 107 is useful to reduce the volume of the assembly by lowering spool dispenser tray 31 and bead 105 allows additional volume within shell housing 3 allowing taller parts to be printed. In lieu of beads welded or fastened rings may be employed.

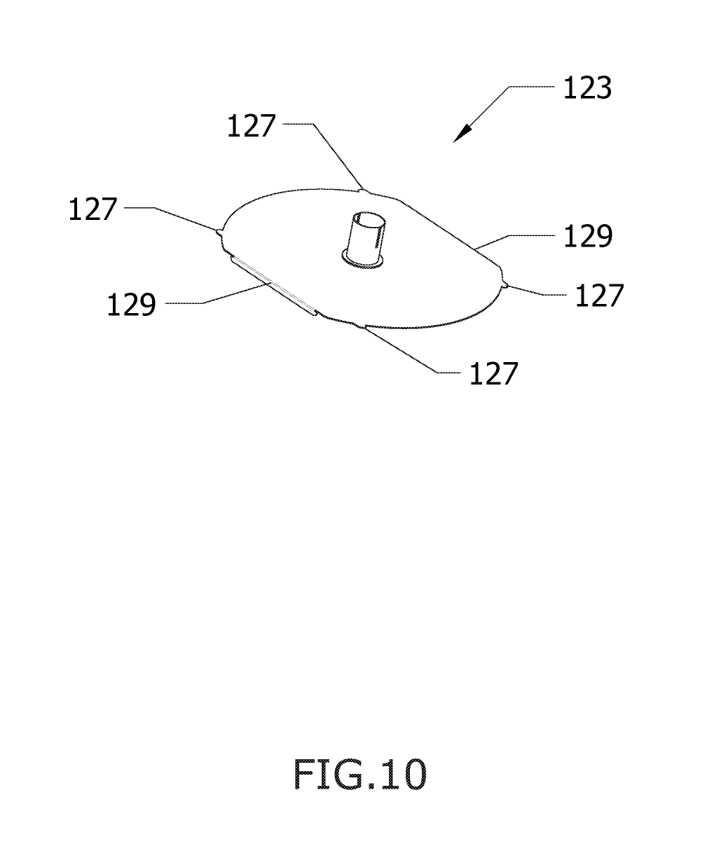

FIG. 10 shows spool dispenser tray 123 with tabs 127 and cord side cuts with ribs 129.

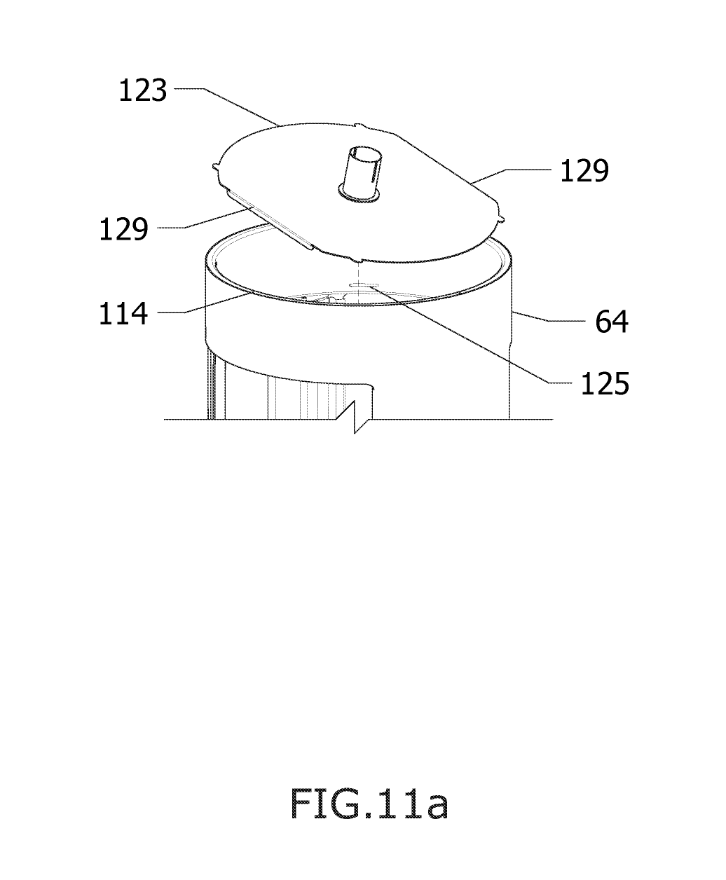

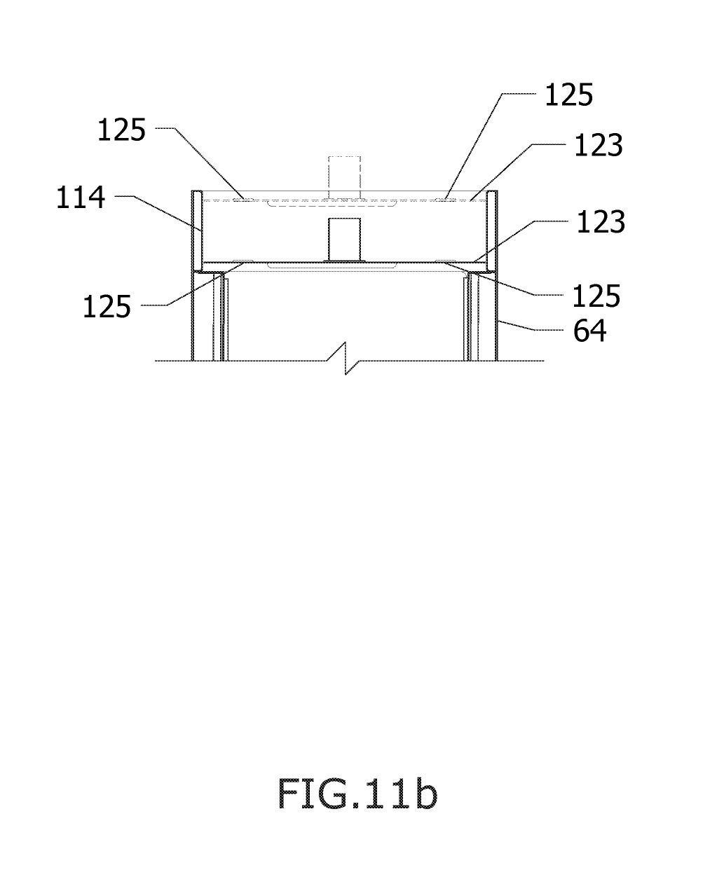

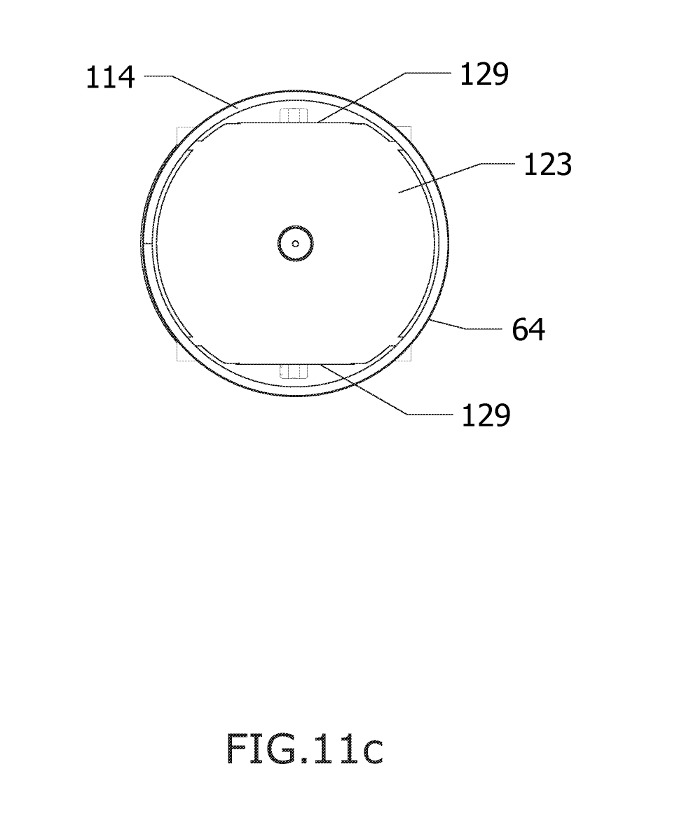

FIG. 11a is an isometric view of spool dispenser tray 123 with tabs 127 being inserted into slots 125 of channel ring 114.

FIGS. 11b -11c are side section and plan views respectively of spool dispenser tray 123 supported by channel ring 114 in both the upper and lower positions. Channel ring 114 has 8 slots 125, 4 upper and 4 lower to accommodate tabs 127 of spool dispenser tray 123 in each position. Spool dispenser tray 123 has cord side cuts with ribs 129 in order to provide strength in the unsupported areas. Spool dispenser tray has two positions for the same reasons described for the embodiment shown in FIGS. 9a-9c.

In an example embodiment, there is provided a method for manufacturing a housing for a 3D printer or 3D scanner. The method includes: cutting a flat blank including apertures with shear, die, grinder, laser, saw or water jet cutter; and rolling the blank to diameter; welding or fastening the rolled blank to itself to form a cylindrical shell housing.

In an example embodiment, there is provided a method for manufacturing a housing for a 3D printer or 3D scanner. The method includes: providing a cylindrical shell housing; and cutting apertures in the cylindrical shell housing using grinder, torch, laser, saw or water jet cutter.

In an example embodiment, the method further includes cutting the cylindrical shell housing to length using the grinder, torch, laser, saw or water jet cutter.

In an example embodiment, the method further includes prior to cutting, rolling a flat blank excluding apertures to diameter; and welding or fastening the rolled blank to itself to form the cylindrical shell housing.

In an example embodiment, there is provided a 3D printer or 3D scanner, including: a unitary housing of generally vertically oriented cylindrical form; wherein the housing defines apertures; and a generally horizontal platform within the unitary housing.

In an example embodiment, the platform extends through at least one of the apertures past an exterior of the unitary housing.

In an example embodiment, the 3D printer or 3D scanner further includes at least one rigid ring which is circumscribed by an interior of the unitary housing. In an example embodiment, the at least one rigid ring supports at least one component within the unitary housing.

In an example embodiment, the 3D printer or 3D scanner further includes at least one rigid disc which is circumscribed by an interior of the unitary housing. In an example embodiment, the at least one rigid disc supports the platform or at least one component within the unitary housing. In an example embodiment, the platform comprises a build platform.

Variations may be made to some example embodiments, which may include combinations and sub-combinations of any of the above. The various embodiments presented above are merely examples and are in no way meant to limit the scope of this disclosure. Variations of the example embodiments described herein will be apparent to persons of ordinary skill in the art, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

1. A method for manufacturing a housing for a 3D printer or 3D scanner, comprising:
cutting a flat blank including apertures with shear, die, grinder, laser, saw or water jet cutter;
rolling the blank to diameter; and
welding or fastening the rolled blank to itself to form a cylindrical shell housing.

2. A method for manufacturing a housing for a 3D printer or 3D scanner, comprising:
providing a cylindrical shell housing; and
cutting apertures in the cylindrical shell housing using grinder, torch, laser, saw or water jet cutter.

3. The method of claim 2, further comprising cutting the cylindrical shell housing to length using the grinder, torch, laser, saw or water jet cutter.

4. The method of claim 2, further comprising:
prior to cutting, rolling a flat blank excluding apertures to diameter; and
welding or fastening the rolled blank to itself to form the cylindrical shell housing.

5. A 3D printer or 3D scanner, comprising:
a unitary housing of generally vertically oriented cylindrical form;
wherein the housing defines apertures; and
a generally horizontal platform within the unitary housing.

6. The 3D printer or 3D scanner of claim 5, wherein the platform extends through at least one of the apertures past an exterior of the unitary housing.

7. The 3D printer or 3D scanner of claim 5, further comprising at least one rigid ring which is circumscribed by an interior of the unitary housing.

8. The 3D printer or 3D scanner of claim 7, wherein the at least one rigid ring supports at least one component within the unitary housing.

9. The 3D printer or 3D scanner of claim 5, further comprising at least one rigid disc which is circumscribed by an interior of the unitary housing.

10. The 3D printer or 3D scanner of claim 9, wherein the at least one rigid disc supports the platform or at least one component within the unitary housing.

11. The 3D printer or 3D scanner of claim 5, wherein the platform comprises a build platform.
